(19) United States
(12) Patent Application Publication
(10) Pub. No.: US 2011/0174693 A1
(43) Pub. Date: Jul. 21, 2011

(54) METHOD FOR SEPARATING OIL FROM WATER BY INJECTING SIMULTANEOUSLY A LIQUIFIED GAS INTO THE GRAVITY SEPARATION DEVICE

(75) Inventors: Karsten Rabe, Porsgrunn (NO); Erling Tor Heitmann, Porsgrunn (NO)

(73) Assignee: KANFA MATOR AS, Porsgrunn (NO)

(21) Appl. No.: 13/002,635

(22) PCT Filed: Jul. 7, 2009
(86) PCT No.: PCT/GB2009/001681

§ 371 Date: Mar. 23, 2011

(30) Foreign Application Priority Data
Jul. 7, 2008 (GB) 0812400.0

(51) Int. Cl. C10G 31/00; B01D 17/04; B01D 11/04

(52) U.S. Cl. 208/308; 210/205; 210/207; 210/196; 210/195.1

(57) ABSTRACT

The invention provides a method of phase separation of a hydrocarbon containing mixed phase fluid composition into at least two separted fluid phases which method comprises introducing (8) a hydrocarbon-containing composition into a phase separator (1) and withdrawing at least two said separated fluid phases (12, 13, 14) from said separator (1), whereby a lipophilic liquefied gas is simultaneusly introduced (24, 19, 17) into said separator (1) with said composition or, preferably, into a fluid-filled region of said separator (1).

The present invention relates to improvement in and relating to the separation of mixed phase hydrocarbon-containing fluids, in particular hydrocarbon or water flows from a subterranean formation, e.g. from an oil well, and to apparatus for use in such processes.

The fluid flow from an oil well typically comprises gas, liquid oil, water and solids e.g. sand. To produce a marketable product, these must be separated as far as possible from each other. The separated water, the “produced water”, and solids may be returned to the environment if their purity complies with regulatory requirements. Thus, for example, produced water may be released into the sea in the case of an offshore production facility.

Many such mixed phase separators are known, for example vortex, cyclone and gravity separators. However there remains a need to improve the performance of such separators.

In a gravity separator, for example, the mixed phase feedstock is fed into a tank allowing the phases to separate out to a gas phase, an oil phase, a water phase and a solids phase in vertically descending order. Outlets for continuous gas, oil and water removal from the tank are placed within the separated gas, oil and water phases respectively. The solids phase may typically be removed periodically, e.g. by water jetting during cleansing of the apparatus.

We have found that the purity of the separated phases taken from mixed phase separators, i.e. the extent to which one separated phase is contaminated by material from another phase, is enhanced if a lipophilic liquefied gas is injected into the mixture to be separated by the separator within the separator, preferably in a zone in which separation has at least partially occurred. The gas used may be any gas which is lipophilic in liquefied form but is preferably a hydrocarbon gas, e.g. a condensate from gas separated from the fluid flow from the subterranean formation. Such condensates typically contain a mixture of C₁ to C₁₀ hydrocarbons, predominantly C₃ to C₈ hydrocarbons. By gas in this context it is meant that at ambient conditions, e.g. 21° C. and 1 atm, the material is gaseous rather than liquid.

Viewed from one aspect the invention thus provides a method of phase separation of a hydrocarbon containing mixed phase fluid composition into at least two separated fluid phases which method comprises introducing a hydrocarbon-containing composition into a phase separator and withdrawing at least two said separated fluid phases from said separator, characterised in that a lipophilic liquefied gas is simultaneously introduced into said separator with said composition or, preferably, into a fluid-filled region of said separator.

The liquefied gas may be introduced directly into the separator, into the hydrocarbon composition immediately before it enters the separator, or into a further fluid phase which itself is introduced directly into the separator or into the hydrocarbon composition immediately before it enters the separator. Where the liquefied gas is introduced into the hydrocarbon composition immediately before it enters the separator, it is preferably first mixed into a further, generally aqueous, carrier fluid. Further liquefied gas may, if desired, be introduced earlier into the hydrocarbon composition before it is fed into the separator, again optionally pre-mixed with a carrier fluid.

The introduction of the liquefied gas into the separator separately from the hydrocarbon composition is especially effective.

In one, particularly preferable, embodiment the liquefied gas is introduced into the separator separately from the hydrocarbon composition but after introduction into a further fluid phase, in particular an aqueous phase (an aqueous carrier phase), and especially a part of a separated aqueous phase withdrawn from and being recycled into the separator. In this case, the liquefied gas will typically be used at 0.05 to 10% vol., especially 0.1 to 5% vol., particularly about 1% vol. of the aqueous carrier phase. The proportion of the withdrawn aqueous phase to be recirculated in this way is preferably 2 to 30% vol., especially 5 to 20% vol., particularly about 10% vol. In general the liquefied gas will typically be used at 0.001 to 5% vol., particularly 0.05 to 2% vol., especially about 1% vol. relative to the mixed phase hydrocarbon composition the separator is to separate.

Where it is desired to improve oil-from-water separation, it is preferred that the liquefied gas be introduced in one or more of the following manners: into a liquid phase of the at least partially separated mixed phase hydrocarbon composition, preferably at the oil/water phase boundary layer and optionally pre-mixed with an aqueous carrier phase; into or through the vortex definer of a vortex or cyclone separator, again optionally but less preferably pre-mixed with an aqueous carrier phase; and at the base of a separator as described earlier.

Where it is desired to improve gas-liquid phase separation, it is preferred to introduce the liquefied gas at or above the gas-liquid phase boundary of the separator, e.g. at the roof of a gravity separator. While the liquefied gas may in this context be pre-mixed with an aqueous carrier phase, this is generally less desirable.

Where it is desired to improve oil-from-solids separation, for example in a gravity separator, it is preferred that the liquefied gas also be introduced at the base of the separator so that it flows through any bed of settled particles (e.g. sand). As the base of the separator contains such a bed of sediment, it is not considered to be a fluid-filled region of the separator for the purposes of the invention. In this instance it is preferred that the gas be introduced in an aqueous carrier phase as mentioned above.

To ensure thorough mixing of the liquefied gas and the relevant parts of the composition to be separated, it is desirable to introduce the liquefied gas upstream of a static mixer or, more preferably, through a plurality of inlet ports, for example the perforations of a perforated inlet pipe, pipe-mesh, tray or the like. In such “distributors”, the inlet ports may thus be in a linear array, or a two or three dimensional array, e.g. on a flat or curved surface.

Where the liquefied gas is introduced into the hydrocarbon composition upstream of and immediately before entry into the separator, this is preferably no earlier than 1 minute before entry into the separator, especially no earlier than 10 seconds before entry, so that the relevant introduction port may form part of the overall separator apparatus or may be attached to the feed line in the vicinity of the separator.

The method of the invention may be used with existing mixed phase fluid separators with only relatively minor structural modifications, e.g. the provision of a liquefied gas source, inlets for the liquefied gas, dividing and recycling loops for the aqueous phase, etc.

Thus viewed from a further aspect the invention provides apparatus for separating a fluid hydrocarbon composition into at least two separated fluid phases, said apparatus comprising a separation zone having an inlet for a fluid hydrocarbon composition and at least two outlets for separated fluid phases, said apparatus further comprising an inlet for a lipophilic liquefied gas disposed at a location in said separation zone which in operation is fluid-filled whereby to allow said liquefied gas to contact the hydrocarbon composition or at least one said separated fluid phase before its withdrawal through a said outlet.

The temperature and pressure at which a liquefied gas is liquid depends on the chemical composition of the gas. In general, the higher the temperature the greater the pressure that is required. Since it is preferred that ice should not form in the separator, where the hydrocarbon feed is water-containing it is preferred that the temperature within the separator should not fall below 0° C. and thus, depending on the choice of liquefied gas, a heater may be required for the separator or the separator should be capable of withstanding elevated pressure. Either such modification of existing separator design is technically straightforward; however, the use of gas condensates as mentioned above is particularly preferable as such modifications are then generally not required. The pressure within the separator may of course be adjusted by modification of the rate of gas withdrawal or by gas injection. Thus the phase separator is preferably used according to the invention on an incoming relatively high temperature and pressure hydrocarbon stream from a well head, e.g. at 50 to 60° C. and 10 to 100 bar, in which the removed gas phase is relatively low molecular weight, e.g. C₁₋₃, hydrocarbons. The raw material for a gas condensate thus enters the separator as part of the hydrocarbon feed and leaves with the oil phase. The gas from which a gas condensate may be produced may then be removed from the oil phase in a lower pressure downstream apparatus, e.g. a gas scrubber. This gas can then be cooled and, at least in part, recycled to the separator as a gas condensate. Desirably, therefore, the separator has feed lines for the mixed phase composition, the liquefied gas, and, optionally, a recycled stream of separated water, as well as discharge lines for gas, liquid hydrocarbon and water. Where water is recycled, a flow divider (e.g. a pipe tee or valve) and a pump will preferably be provided in the recirculation unit. Other pumps may be provided as desired in the feed and discharge lines.

The benefits of the invention apply to all four phases of the output of a hydrocarbon well—oil, gas, water and solids—as well as to the maintenance, and operating life of the separators. Thus the values of the separated oil and gas phases are increased by virtue of the reduction in, the water and solids contents, the produced water is more environmentally tolerable due to reduction in the oil and solids contents, and the sediments deposited in the separator are easier and safer to flush out and dispose of due to reduction in the oil content. Reduction in solids content of the separated fluid phases, moreover, leads to reduction in abrasive wear on the discharge conduits of the separators.

While the hydrocarbon composition to be separated according to the invention is preferably an oil/water mixture (which may be either majoratively oil or majoratively water), the invention is also applicable to oil/gas mixtures as gas recovery can thereby be enhanced since the liquefied gas may serve to enhance bubble formation.

Preferred embodiments of the method and apparatus of the invention will now be described with reference to the accompanying drawings, in which:

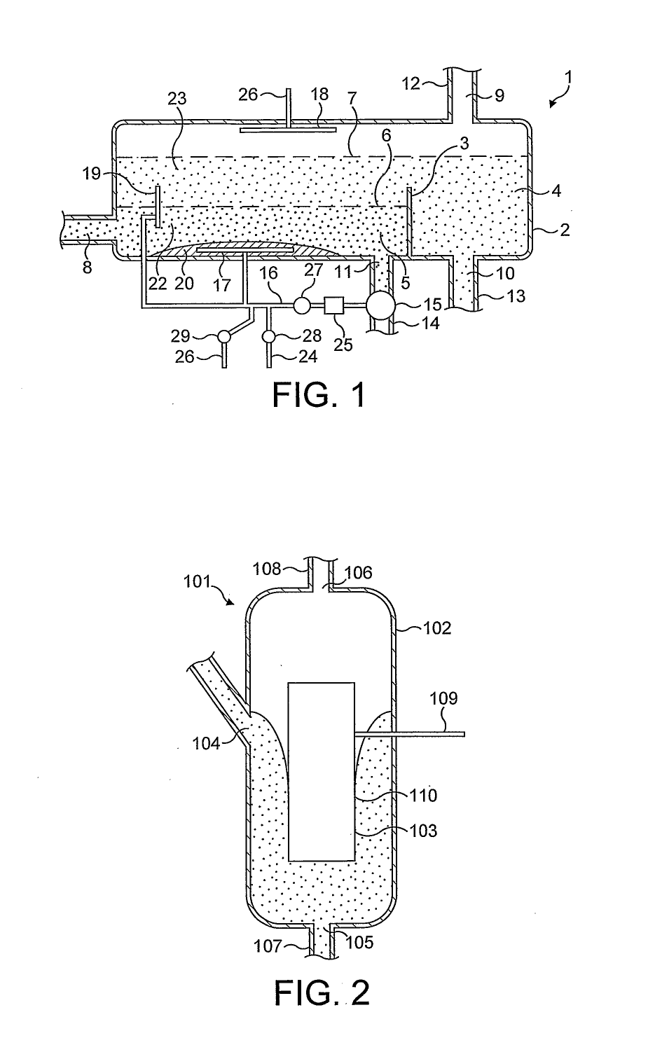

FIG. 1 is a diagrammatic sketch of a first embodiment of a separator according to the invention, a gravity separator; and

FIG. 2 is a diagrammatic sketch of a second embodiment of a separator according to the invention, a cyclone separator.

Referring to FIG. 1 there is shown a separator 1 having a separation vessel 2 divided by a dividing wall 3 into oil and water discharge zones 4 and 5. The oil-water phase boundary 6 for the liquid in the separator lies below the top of wall 3, while the gas-oil phase boundary 7 lies above the top of well 3. A hydrocarbon composition for separation is fed into the separation vessel upstream of wall 3 through inlet port 8. Gas, oil and water are removed from the separation vessel through outlet ports 9, 10 and 11 and into conduits 12, 13 and 14 respectively. Conduit 14 is provided with a pipe tee 15 allowing part of the water flow to be recirculated through conduit 16 and inlet distributors 17 and 19 into the separation vessel. The water flow may be any possible water return flow to the separator, for example: water from downstream separators in the oil train; reject or skimming water from water treatment equipment such as hydrocyclones, flotation units and degassers; and recirculation streams from closed drain and other water collection vessels. Distributors 17 and 19 are in the form of perforated trays or grids of perforated pipes arranged horizontally and vertically respectively, in the latter case perpendicular to the flow direction within the separation vessel. Distributor 17 is located at the base of the separation vessel so that fluid passing through it will also pass through the sediment bed 20 which forms at the base of the separation vessel. Distributor 19 is arranged at the upstream end of the separation vessel so that fluid passing through it will pass both into the lower water layer 22 and the upper oil layer 23. A further distributor 18, fed through conduit 26 with gas condensate from a source (not shown) such as for example a secondary scrubber unit, and also in the form of a horizontally arranged perforated tray or pipe grid, is arranged at the roof of the separation vessel, above the gas-liquid phase boundary 7 so that fluid passing through it will contact any foam or scum at that boundary.

Conduit 16 is provided with a pump and an inlet 24 for gas condensate from the gas condensate source.

Conduit 16 is also provided with an inlet 26 for water from downstream separators in the oil train, for reject or skimming water from water treatment equipment such as hydrocyclones, flotation units and degassers, or for recirculation streams from closed drain and other water collection vessels. Lines 16, 24 and 26 may be provided with valves 27, 28 and 29 so that the material supply may be selected as desired.

Referring to FIG. 2 there is shown a gas-liquid cyclone separator 101 having an upright cylindrical separation vessel 102 containing a vortex definer 103. Gas-containing liquid is introduced into the separation vessel through a tangentially arranged inlet 104. Gas and liquid phases are drawn off from the separation vessel through lower and upper outlet ports 105 and 106 and conduits 107 and 108 respectively. As in the embodiment of FIG. 1, gas condensate from a source (not shown in this Figure) is introduced via conduit 109 to a distributor 110 which also functions as the vortex definer. As shown, distributor 110 is in the form of a vertical perforated cylinder which closes the top of the vortex and prevents gas leaving with the liquid phase. In operation, the separated liquid phase contains oil, water and solids and is then desirably fed to a further separator to separate these from each other, e.g. a separator as shown in FIG. 1.

The apparatus of FIG. 1 moreover may desirably be modified so that the hydrocarbon feed enters the separator through an inlet cyclone, i.e. so that a cyclone substantially as shown in FIG. 2 is located within the gravity separator itself. Liquefied gas is desirably introduced into this inlet cyclone substantially as described for FIG. 2.

1. A method of phase separation of a hydrocarbon containing mixed phase fluid composition into at least two separated fluid phases which method comprises introducing a hydrocarbon-containing composition into a phase separator and withdrawing at least two said separated fluid phases from said separator, characterised in that a lipophilic liquefied gas is introduced into said separator simultaneously with said composition or is introduced into a fluid-filled region of said separator.

2. A method as claimed in claim 1 wherein liquefied gas is introduced into said separator pre-mixed with an aqueous fluid withdrawn from said separator.

3. A method as claimed in claim 1 wherein said liquefied gas comprises a hydrocarbon gas condensate.

4. A method as claimed in claim 1 wherein liquefied gas is introduced at a base of said separator.

5. A method as claimed in claim 1 wherein liquefied gas is introduced above a gas/liquid phase boundary in said separator.

6. A method as claimed in claim 1 wherein liquefied gas is introduced adjacent a liquid/liquid phase boundary in said separator.

7. A method as claimed in claim 1 wherein said hydrocarbon-containing composition is introduced into said separator through an inlet cyclone.

8. Apparatus for separating a fluid hydrocarbon composition into at least two separated fluid phases, said apparatus comprising a separation zone having an inlet for a fluid hydrocarbon composition and at least two outlets for separated fluid phases, said apparatus further comprising an inlet for a lipophilic liquefied gas disposed at a location in said separation zone which in operation is fluid-filled whereby to allow said liquefied gas to contact the hydrocarbon composition or at least one said separated fluid phase before withdrawal of said at least one separate fluid phase through an outlet of said at least two outlets.

9. Apparatus as claimed in claim 8 in the form of a gravity separator.

10. Apparatus as claimed in claim 9 wherein said inlet comprises an inlet cyclone.

11. Apparatus as claimed in claim 8 in the form of a cyclone separator.

12. Apparatus as claimed in claim 8 in the form of a vortex separator.

13. Apparatus as claimed in claim 8, further comprising an inlet for return of recirculated water to the separation zone.

14. Apparatus as claimed in claim 13 wherein said inlet is for return of water from at least one separator arranged downstream of the apparatus in the same fluid hydrocarbon train.

15. Apparatus as claimed in claim 13 wherein said inlet is arranged to receive reject or skimming water from water treatment equipment comprising any of a hydrocyclone, a flotation unit, and a degasser.

16. A method as claimed in claim 1, wherein said lipophilic liquefied gas is introduced into a fluid-filled region of said separator.

17. A method as claimed in claim 1, wherein said lipophilic liquefied gas is introduced into said separator simultaneously with said composition.

18. Apparatus as claimed in claim 13, wherein said inlet is arranged to receive a recirculation stream from any of a closed drain and a water collection vessel.
